(19) United States
(12) Patent Application Publication
(10) Pub. No.: US 2008/0270460 A1
(43) Pub. Date: Oct. 30, 2008

(54) Creating a data structure that specifies relationships between networked objects

(76) Inventors: Daniel W. Hepner, Cupertino, CA (US); Shaila Joshi, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,170

(22) Filed: Apr. 27, 2007

(51) Int. Cl. G06F 17/30

(52) U.S. Cl. 707/103 R

(57) ABSTRACT

Embodiments of the present invention pertain to creating a data structure that specifies relationships between networked objects. According to one embodiment, information indicating a degree to which a computer potentially satisfies a condition between a software program and an object is received. The computer and the object are associated with a network. A data structure that specifies the condition between the software program and the object and specifies a degree to which the computer potentially satisfies the condition is created based on the received information.

### TECHNICAL FIELD

Embodiments of the present invention relate to relationships between networked objects. More specifically, embodiments of the present invention relate to creating a data structure that specifies relationships between networked objects.

### BACKGROUND ART

Frequently objects, such as software programs, computers, and storage, have dependencies on each other. For example, a network may enable software programs that execute on various computers to write data to storage or to access data on the storage, or a combination thereof. Examples of software programs include but are not limited to applications and workloads.

When a computer system that a particular software program is executing on fails or experiences degraded performance, the software program may be moved to another computer system. In order to choose the computer system that the software program will be moved to, the objects that the software program depends on are determined. For example, if a software program A depends on accessing a particular data set B that resides on a particular storage device C, then the software program A depends on the storage device C. In this case, the software program A will be moved to a computer system that has connectivity to the storage device C.

In another example, software program A may not have started executing yet. However, a computer system that is capable of providing software program A connectivity to storage device C may still be selected for executing software program A.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of relationships between networked objects that are displayed, according to one embodiment.

FIG. 2 depicts a data structure for specifying relationships between networked objects, according to one embodiment.

FIG. 3 is a block diagram of a system for creating a data structure that specifies relationships between networked objects, according to one embodiment.

FIG. 4 is a flowchart of a method for creating a data structure that specifies relationships between networked objects, according to one embodiment.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, components, and circuits have not been described in detail as not to unnecessarily obscure aspects of the present invention.

### Overview

When an application controller is selecting a computer system for executing a software program, a person may want to monitor the situation. The person may decide to allow the application controller to automatically proceed with the course of action that the application controller has determined or the person may decide to cause the application controller to take a different course of action. For example, the application controller may automatically select computer A to run software program B on. The person may decide to allow the system to proceed and execute software program A on computer system F or the person may decide to instruct the application controller to execute software program B on computer system C.

According to one embodiment, relationships between networked objects are displayed to enable the human to monitor the application controller. According to one embodiment, a method and system for specifying relationships between networked objects is provided as a part of enabling the display of the relationships to a human, as will become more evident.

### A Visual Representation of Relationships Between Networked Objects

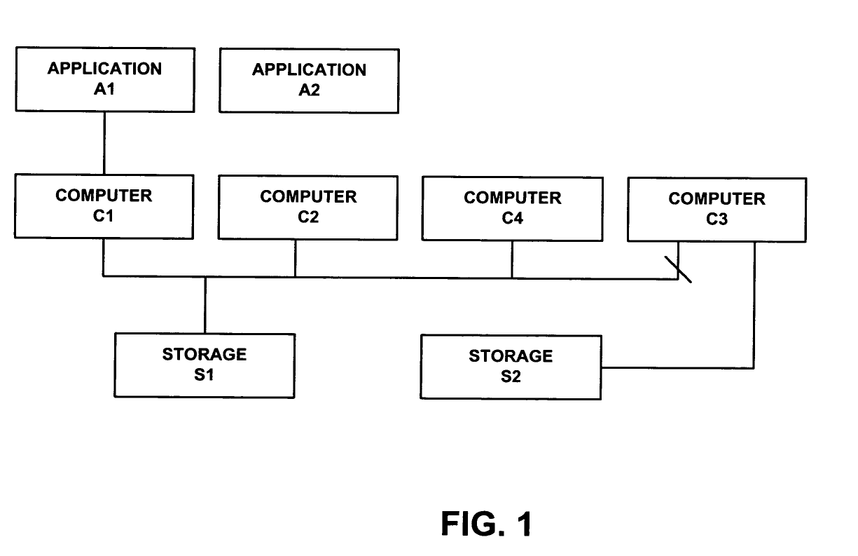

FIG. 1 is a block diagram of relationships between networked objects that are displayed, according to one embodiment. FIG. 1 includes computers C1-C4, storage S1 and S2, and applications A1 and A2. The computers C1-C4 and the storage S1 and S2 may be a part of a storage area network (SAN). However, the computers C1-C4 and the storage S1 and S2 may be networked together without using a SAN.

Applications A1 and A2 are examples of software programs. A software program, according to one embodiment, can be any kind of program that at least in part includes software instructions. The software program for example can include one or more applications, workloads, and web services, among other things.

The computers C1-C4, the storage S1 and S2 and the applications A1 and A2 are examples of objects that may have relationships with each other. Other examples of objects include, but are not limited to, switches, networks, SANs, and internet protocol (IP) addresses.

Computers C1, C2, and C4 are able to access storage S1. Computer C3 cannot access storage S1, for example, because the connection between computer C3 and storage S1 has failed or because computer C3 is down. The line drawn through the line connecting computer C3 to storage S1 is one way of visually indicating that computer C3 cannot access storage S1. Computers C1 and C3 are able to access storage S2.

Application A1 is currently executing on computer C1 and accesses a dataset on storage S1. Application A2 is not currently executing on any computer but will access a dataset on storage S2 when application A2 is executed. To illustrate FIG. 1, assume that applications A1 and A2 both require a large amount of memory in order to execute, therefore, applications A1 and A2 will not be executed on the same computer at the same time. They can be executed at the same time on different computers. Computer C1 and C3 would provide application A2 access to storage S2, however, application A2 should not be executed on the same computer as A1 so, according to one embodiment, computer C3 would be selected for executing application A2.

Various methods of depicting relationships can be used. For example, relationships can be depicted with lines between objects that are currently available to each other as is the case between application A1 and computer C1, or between computers C1, C2, C4 and storage S1, among other things. In another example, relationships can be depicted by not having lines between objects, such as application A1 and A2, which are exclusive to each other or not available to each other. In yet another example, relationships can be depicted by having a line drawn through a line to indicate that one object is not available to another, such as computer C3 and storage S1. Other ways of visually representing relationships can be used. For example, lines with different colors can be used to visually represent various relationships between objects or the blocks that represent objects can be color coded. In another example, text describing relationships can be associated with a visual representation of an object. For example, the text “S1” inside of the box for application A1 indicates that application A1 depends on storage S1. Similarly the text “S2” inside of the box for application A2 indicates that application A2 depends on storage S2.

According to one embodiment, the visual representation of relationships between objects changes as the cursor is moved over various parts of the visual representation to provide more detail about relationships pertaining to an object in close proximity to the curser and less detail about relationships pertaining to objects that are further away from the cursor. For example, if the cursor is close to the block for application A1 a line between application A1 and storage S1 may appear. When the cursor is moved closer to application A2 the line between application A1 and storage S1 may disappear but another line from application A2 to storage S2 may appear.

As will become more evident, a data structure is used to determine how to display relationships between networked objects. According to one embodiment, the data structure includes a desired condition between a software program and an object. The data structure also includes a degree to which the computer potentially satisfies the condition, for example, if the computer is selected to execute the software program. This data structure makes it easy to display relationships between networked objects, as will become more evident.

### A Condition Between a Software Program and an Object

According to one embodiment, a condition between a software program and an object is desired. Examples of a desired condition include, but are not limited to, available, exclusive, and coexists. A condition can be specified with a numeric, a character, an alphanumeric or text, among other things.

Referring to FIG. 1, since the dataset on storage S1 needs to be accessed by the application A1, an example of a condition between application A1 and storage S1 is “available.” Similarly, the condition “available” can be used to indicate that application A2 needs to access a dataset on storage S2. Since application A1 and A2 should not be executed on the same computer, an example of a condition between application A1 and A2 is exclusive.

### A Degree of Potentially Satisfying a Condition

According to one embodiment, a degree to which a computer potentially satisfies a condition between a software program and an object can be specified. Examples of degrees of potentially satisfying conditions include, but are not limited to, satisfied, not satisfied, or some value in a range. A degree can be specified with a numeric, a character, an alphanumeric or text, among other things. The degree may specify how well a condition is satisfied, such as satisfied, not satisfied, below average, average, above average. A value in a range may be used to indicate how well a computer satisfies a condition. For example, the range may be 1-10 where 1 indicates a condition is not satisfied and 10 indicates the condition is satisfied. A degree of 7 would indicate that a computer provided a higher than average level of satisfying a condition.

### A Data Structure that Specifies Relationships Between Networked Objects

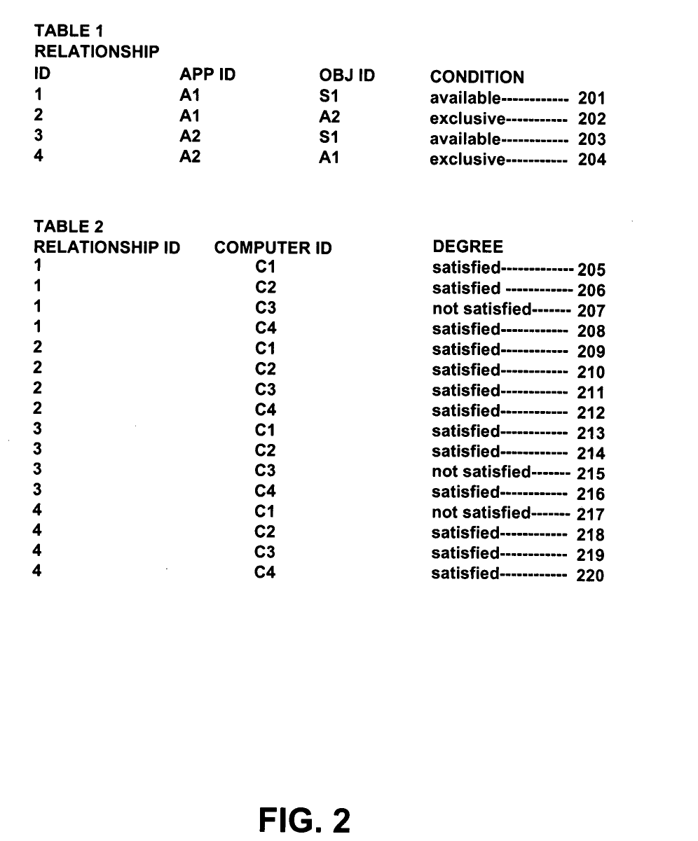

FIG. 2 depicts a data structure for specifying relationships between networked objects, according to one embodiment. A data structure can be used to determine how to display relationships between networked objects.

According to the embodiment depicted in FIG. 2, the data structure is a schema. The schema includes two tables. The columns for Table 1 are a relationship ID, an application ID, an object ID and a condition. Each row in Table 1 specifies a condition between an application and an object. The columns for Table 2 are relationship ID, which refers back to the relationship ID's from Table 1, computer ID, and degree. Each row in Table 2 specifies a degree to which a computer potentially satisfies a condition depicted in a row in Table 1.

For example, the first row 201 in Table 1 specifies a condition of available between application A1 and storage S1. The second row 202 in Table 1 specifies a condition that application A1 is exclusive to A2. The third row 203 of Table 1 specifies a condition of available between application A2 and storage S2. The fourth row 204 in Table 1 specifies a condition that application A2 is exclusive to application A1.

The first 4 rows 205-208 of Table 2 pertain to the condition between application A1 and storage S1 designated by relationship ID 1. The next 4 rows 209-212 of Table 2 pertain to the condition between application A1 and application A2 designated by relationship ID 2. The next 4 rows 213-216 of Table 2 pertain to the condition between application A2 and storage S2 designated by relationship ID 3. The last 4 rows 214-220 of Table 2 pertain to the condition between applications A2 and A1 designated by relationship ID 4.

Rows 205, 206 and 208 of Table 2 specify that computers C1, C2 and C4 satisfy the condition for the relationship between application A1 and storage S1. For example, if application A1 was executed on any one of the computers C1, C2 or C4, the dataset on storage S1 would be available, which is the condition specified in Table 1's first row 201, to application A1. The third row 207 of Table 2 specifies that computer C3 does not satisfy the condition for the relationship between application A1 and storage S1. For example, referring to FIG. 1, computer C3 cannot communicate with storage S1, therefore computer C3 would not satisfy the condition of “available” between application A1 and storage S1.

Referring to rows 209-212 computers C1-C4 satisfy the condition “exclusive” between applications A1 and A2. Referring to rows 213-216, computers C1 and C3 satisfy the condition “available” between application A2 and storage S2 but computer C2 and C4 does not satisfy the condition “available” because they do not have connectivity to storage S2. Referring to rows 217-220, computers C2-C4 satisfy the condition “exclusive” for application A2 to application A1 but computer C1 does not satisfy the condition “exclusive” for application A2 because application A1 is currently executing on computer C1. The intersection between computers C1 and C3 for relationship ID 3 and computers C2, C3 and C4 for relationship ID 4 results in computer C3. Therefore, for this illustration, application A2 would be executed on computer C3, according to one embodiment.

The embodiment depicted in FIG. 2 illustrates degrees of satisfied or not satisfied. However, as described herein, degrees may be specified with values from a range of possible degrees. For example, assume that an application A can be executed on either computer B or C but computer C is preferred because it is capable of executing application A more quickly due to computer C having more processing power than computer B. In this case, the degree for computer B for example may have a value of 4 whereas the degree for computer C may have a value of 7.

In order to facilitate understanding, the data structure depicted in FIG. 2 is a simple example. However, a data structure created using various embodiments can be used to display any level of complexity of relationships between objects.

### A System for Creating a Data Structure that Specifies Relationships Between Networked Objects

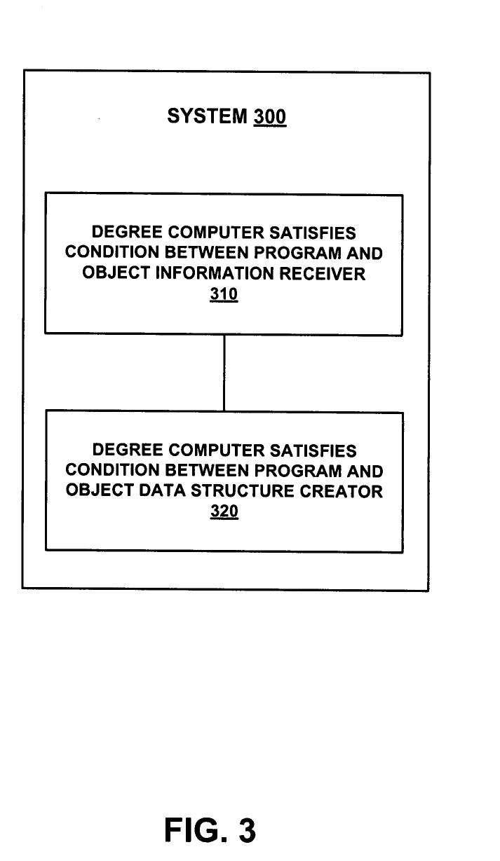

FIG. 3 is a block diagram of a system for creating a data structure that specifies relationships between networked objects, according to one embodiment. The blocks that represent features in FIG. 3 can be arranged differently than as illustrated, and can implement additional or fewer features than what are described herein. Further, the features represented by the blocks in FIG. 3 can be combined in various ways. The system 300 can be implemented using software, hardware, firmware, or a combination thereof.

The system 300 includes a degree-computer-satisfies-condition-between-program-and-object-information-receiver 310 (referred to hereinafter as an “information receiver”) and a degree-computer-satisfies-condition-between-program-and-object-data-structure-creator 320 (referred to hereinafter as “data structure creator”). The information receiver 310 and the data structure creator 320 are communicatively coupled, according to one embodiment.

The information receiver 310 is configured for receiving information indicating a degree to which a computer potentially satisfies a condition between a software program and an object, for example, if the computer were selected to execute the software program. The data structure creator 320 is configured for creating a data structure based on the received information, where the data structure specifies the condition between the software program and the object and specifies the degree to which the computer potentially satisfies the condition, as will become more evident.

### A Method for Creating a Data Structure that Specifies Relationships Between Networked Objects

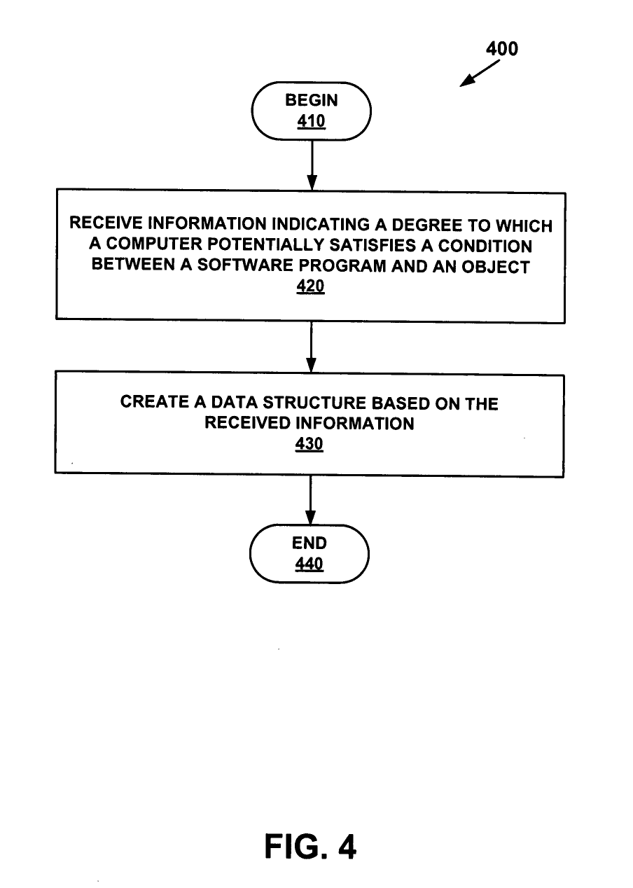

FIG. 4 is a flowchart of a method for creating a data structure that specifies relationships between networked objects, according to one embodiment. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed.

All of, or a portion of, the embodiments described by flowchart 400 can be implemented using computer-readable and computer-executable instructions which reside, for example, in computer-usable media of a computer system or like device. The computer-usable media can be any kind of memory that instructions can be stored on. Examples of the computer-usable media include but are not limited to a disk, a compact disk (CD), a digital video device (DVD), read only memory (ROM), flash, and so on. As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

Step 410, the method begins.

Step 420, information indicating a degree to which a computer potentially satisfies a condition between a software program and an object is received. The computer and the object are associated with a network. For example, an application controller may be used for managing the various objects, such as the computer and storage the software accesses, associated with the network. The application controller may be used to determine when to move a software program and to what computer to move the software program, among other things. The application controller typically uses a text file to obtain information about the objects. However, this text file is complex and is difficult for a human to find information in for the purpose of determining relationships between objects. For example, information the human needs to determining relationships may be scattered around the file. Further, this text file would be very difficult for a programmer that is not familiar with the application controller's technology. According to one embodiment, this text file is received by the information receiver 310.

According to one embodiment, the software program is executing on a computer that is no longer capable of properly executing the software program, for example, because the computer has failed, has lost connectivity to an object the software program has a dependency on, or because the computer's performance has fallen below an acceptable level, among other things. The software program may then be moved to a second computer. Various embodiments can be used to determine whether this second computer potentially satisfies a condition between the software program and an object, for example, as a part of determining whether to move the software program to the second computer.

Step 430, a data structure is created based on the received information. According to one embodiment, the data structure creator 320 uses the text file received by the information receiver 310 to create a data structure as depicted in FIG. 2. The data structure specifies the condition between the software program and the object and specifies the degree to which the computer potentially satisfies the condition based on the received information. Table 1 depicted in FIG. 2 depicts a condition between software programs, such as applications A1 and A2 referred to under the App ID column, and objects, such as storage S1 and application A2 referred to under the Obj ID column. Table 2 depicted in FIG. 2 depicts the degree, referred to under the degree column, to which the computer potentially satisfies the condition. Table 2 refers back to the condition in Table 1 using relationship IDs.

Step 440, the method ends.

According to one embodiment, a data structure that was created using the method described by flowchart 400 is used to display relationships between objects. The data structure is easy to understand so that a programmer that is not familiar with the complexities of the application controller can program an application (referred to herein as the “display application”) to display the relationships. The display application can access the data structure and display a visual representation of relationships between objects as depicted in FIG. 1. A human can use the visual representation of the relationships to monitor the activities of the application controller.

Various embodiments have been described in various combinations. However, any two or more embodiments may be combined. Further, any embodiment may be used separately from other embodiments.

Embodiments of the present invention are thus described. While the present invention has been described in particular embodiments, it should be appreciated that the present invention should not be construed as limited by such embodiments, but rather construed according to the following claims.

What is claimed is:

1. A computer implemented method of creating a data structure that specifies relationships between networked objects, the method comprising:
receiving information indicating a degree to which a computer potentially satisfies a condition between a software program and an object, wherein the computer and the object are associated with a network; and
creating a data structure that specifies the condition between the software program and the object and specifies a degree to which the computer potentially satisfies the condition based on the received information.

2. The computer implemented method as recited by claim 1, wherein the receiving of the information further comprises:
receiving a text file that is used by an application controller that controls relationships between objects associated with the network.

3. The computer implemented method as recited by claim 1, further comprising:
using the data structure to create a visual representation of the relationships between the computer, the object, and the software program.

4. The computer implemented method as recited by claim 3, further comprising:
accessing the data structure with a display application to create the visual representation.

5. The computer implemented method as recited by claim 1, wherein the creating of the data structure further comprises:
creating a database schema.

6. The computer implemented method as recited by claim 1, wherein the receiving of the information indicating the degree to which the computer potentially satisfies the condition between the software program and the object further comprises:
receiving the information indicating the degree to which the computer potentially satisfies the condition between the software program and the object, wherein the object is selected from a group consisting of a second software program, a second computer, storage, a dataset, an internet protocol address, and a storage area network.

7. A system for creating a data structure that specifies relationships between networked objects, the system comprising:
a degree-computer-satisfies-condition-between-program-and-object-information-receiver configured for receiving information indicating a degree to which a computer potentially satisfies a condition between an software program and an object if the computer is selected to execute the software program, wherein the computer and the object are associated with a network; and
a degree-computer-satisfies-condition-between-program-and-object-data-structure-creator configured for creating a data structure based on the received information, wherein the data structure specifies the condition between the software program and the object and specifies a degree to which the computer potentially satisfies the condition.

8. The system of claim 7, wherein the information received by the degree-computer-satisfies-condition-between-program-and-object-information-receiver is a text file that is used by an application controller that controls relationships between objects associated with the network.

9. The system of claim 7, wherein the data structure is used to create a visual representation of the relationship between the computer, the object, and the software program.

10. The system of claim 9, wherein a display application accesses the data structure to create the visual representation.

11. The system of claim 7, wherein the computer and the object are associated with a storage area network.

12. The system of claim 7, wherein the computer is a second computer and the software program was executing on a first computer that is no longer capable of properly executing the software program.

13. The system of claim 7, wherein the data structure includes a first table with columns for an identifier for a relationship between the software program and the object, an identifier for the software program, an identifier for the object and the condition.

14. The system of claim 13, wherein the data structure includes a second table with columns for the identifier for the relationship, an identifier for the computer, and the degree.

15. A data structure for specifying relationships between networked objects, the data structure comprising:
a desired condition between a software program and an object, wherein the computer and the object are associated with a network; and
a degree to which the computer potentially satisfies the condition if the computer is selected to execute the software program.

16. The data structure of claim 15, wherein the data structure includes a first table with columns for an identifier for a relationship between the software program and the object, an identifier for the software program, an identifier for the object and the condition.

17. The data structure of claim 16, wherein the data structure includes a second table with columns for the identifier for the relationship, an identifier for the computer, and the degree.

18. The data structure of claim 15, wherein the degree is selected from a group consisting of satisfied, not satisfied, and a degree that falls within a range.

19. The data structure of claim 15, wherein the condition is selected from a group consisting of available, exclusive, and coexists.

20. The data structure of claim 15, wherein the software program and the computer are objects and wherein the data structure is used to create a visual representation of relationships between objects associated with the network.
